(19) United States
(12) Patent Application Publication
(10) Pub. No.: US 2018/0114193 A1
(43) Pub. Date: Apr. 26, 2018

(54) CALENDAR EVENT TEMPLATES

(71) Applicant: GOOGLE INC., Mountain View, CA (US)

(72) Inventors: Grace Sang Young KWAK, Zurich (CH); Chia-Nee Michelle CHEN, Zurich (CH); Lucia FEDOROVA, Zurich (CH); Astrid WEBER, Zurich (CH)

(73) Assignee: GOOGLE INC., Mountain View, CA (US)

(21) Appl. No.: 14/050,108

(22) Filed: Oct. 9, 2013

(51) Int. Cl. G06Q 10/10

(52) U.S. Cl. CPC G06Q 10/1095

(57) ABSTRACT

A system and method for scheduling and defining calendar events on a user's electronic calendar are disclosed. An exemplary method begins with receiving a main event with a specified date. An event template may be selected that is related to the main event. A user's calendar may then be populated with template events from the event template using the main event date as the date from which template events are offset. Users may modify existing event templates or create their own templates. Additionally, users may modify, delete, or create new events that may be associated with the main event and treated as part of an event group along with events created in a calendar from a specified template.

### BACKGROUND

Planning for an important event or a life-change can be difficult and stressful due to the amount of tasks that need to be completed before and/or after such a big event. One way to make an important event or life-change less daunting is to prepare for the event by scheduling manageable milestones related to the event that can be accomplished in reasonable time increments. Events such as beginning college, starting a new job, moving, planning a wedding, or having a baby can be divided into small tasks that may help a user plan and manage their time without becoming overwhelmed by the main event.

Customary event-planning sites may allow a user to input a date for a main event and provide the user with a list of dates and tasks related to the event. The user may then have to print out or copy and paste the tasks into an electronic calendar. This manual conversion of tasks to an electronic calendar can be tedious and problematic for a user.

As recognized by the inventors, there should be a way for event-planning tasks and after-event tasks related to a main event to automatically populate in a user's electronic calendar.

### SUMMARY

This specification describes technologies relating to calendar presentation in general, and specifically to methods and systems for scheduling and defining events on a user's calendar based on a main event type and date.

In general, one aspect of the subject matter described in this specification can be embodied in a system and method for scheduling and defining calendar events on a user's electronic calendar. An exemplary system may include one or more processing devices and one or more system devices and one or more storage devices storing instructions that, when executed by the one or more processing devices, cause the one or more processing devices to execute steps of an exemplary method. An exemplary method includes: receiving a main event with a specified date and title; allowing a section of an event template, the event template related to the main event and including a plurality of template events with each event having a predefined offset value; and populating the user's calendar with the template events from the event template using the main event date as the date from which template events' assigned dates are offset using the template events' offset values to create an event group on the user's calendar.

A second aspect of the subject matter described in this specification can be embodied in a system and method for creating template events. An exemplary system may include one or more processing devices and one or more system devices and one or more storage devices storing instructions that, when executed by the one or more processing devices, cause the one or more processing devices to execute steps of an exemplary method. An exemplary method includes: receiving a request to create an event template; receiving an event template instance; saving the event template instance as an event template; allowing the template to be selected to populate a user's calendar with events and a date to be specified as a main event date; and upon the template being selected, populating a user's calendar with the template events from the event template using the main event date as the date from which events are offset.

These and other embodiments can optionally include one or more of the following features: responsive to a user deleting the main event, the user may have the option to delete other events within the event group; responsive to a user deleting a template event, the user may have the option to delete related template events and the related main event; selecting an event template related to the main event may include parsing text of the received main event, determining an event type of the main event using auto-selection based on artificial intelligence, machine learning, regular expressions, natural language parsing, context-free grammars, or other parsing rules, and selecting an event template based on the determined event type; an event template schema may be provided with which event template instance can be created; a user may be allowed to customize the event template before the event template is used to populate the user's calendar with events; receiving the template instance may comprise receiving a request to create an event template, receiving a main event, receiving activities with offsets related to the main event, and creating the template instance including events for the received activities related to the main event, where each event in the template instance has a predefined offset value; access control restrictions may limit the availability of templates; created templates may be displayed to users subject to access control restrictions; a user may be allowed to modify populated template events; a user may be allowed to create a calendar event that is associated with the created event group; and template events may have reminders.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram illustrating an exemplary calendar event input.

FIG. 2 is an exemplary event template for moving houses.

FIG. 3 is an exemplary event template for moving houses.

FIG. 4 is an exemplary schema for creating an event template.

FIG. 5 is an exemplary calendar with events populated on the calendar using the event template of FIG. 3.

FIG. 6 is an exemplary calendar with events populated on the calendar using the event template of FIG. 3, but modified by a user.

FIG. 7 is a flow diagram of an exemplary method for scheduling and defining event's on a user's calendar.

FIG. 8 is a flow diagram for creating an exemplary event template.

FIG. 9 is a block diagram illustrating an exemplary computing device.

### DETAILED DESCRIPTION

In general, techniques described in this document may be used to schedule and display events in a user's calendar. An electronic calendar application may display planning tasks and after-event tasks based on a user-specified main event. Aspects of the inventive concepts also provide a way to specify or determine planning tasks and/or after-event tasks and create new calendar event templates that can be used to populate an electronic calendar.

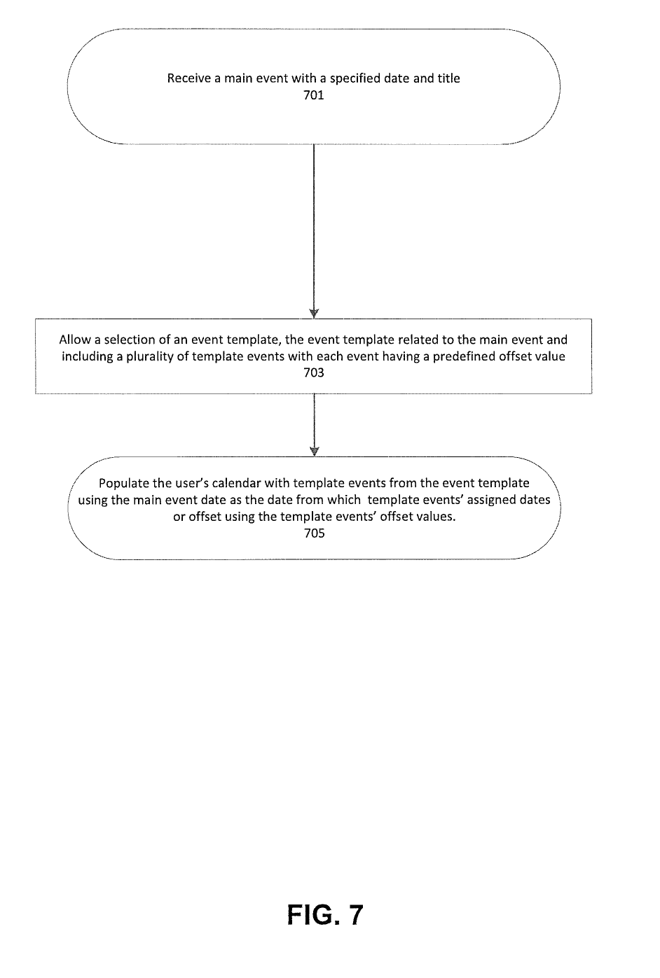

When planning an important event or life-change, a user may need assistance determining all the tasks that need to be completed before and after an event. In an exemplary embodiment, a user may specify the day and optionally specify the type of main event for which the user is planning as illustrated in FIG. 7 (701). An exemplary system may then provide a user with a calendar event template that includes at least one, if not several, suggested events/tasks for the user to undertake. A calendar event template may include a series of events or tasks that are defined as an offset from a main event. An exemplary system may provide templates from which the user may select a template to automatically populate events related to the user's event (703, 705).

Alternatively, an exemplary system may parse the user's created calendar event using artificial intelligence, machine learning, regular expressions, natural language parsing, context-free grammars, or other parsing rules to find text and content that may be used to determine the type of event the user is creating. The system may then automatically select an event template related to the main event and populate the user's calendar with events related to the determined event type. An exemplary system may additionally or alternatively suggest the template that the user may select to populate the electronic calendar (703, 705).

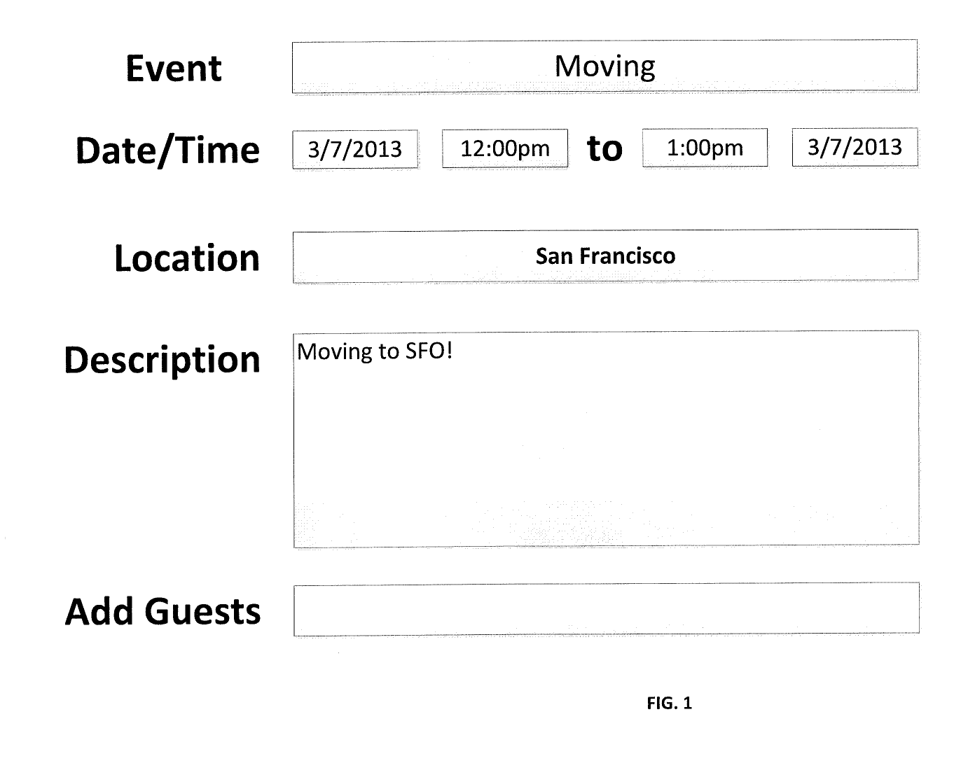

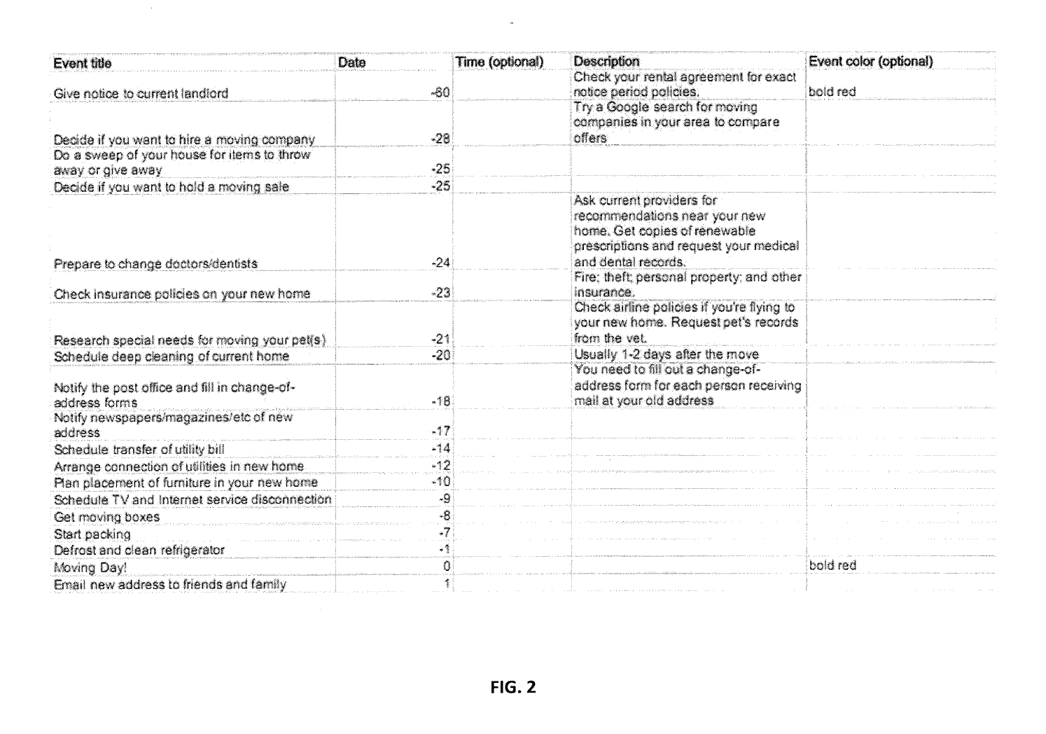

For example, there may be a “moving house” template. A user may enter his or her moving date into his or her calendar as illustrated in FIG. 1. The user may create a calendar specifically for this main event or add the main event to an existing calendar. The user may optionally specify that the event is a moving houses event. In some embodiments, a user may then choose an event template that matches or is related to the moving event the user is creating. In other events, the exemplary system may automatically choose or suggest a moving template based on the information provided by the user. Once a template has been chosen either by the user or the system, the template may be used to populate the user's calendar with moving-related tasks. FIG. 2 illustrates exemplary tasks that may be included in the template. As shown in FIG. 2, templates may include several template events. Things to do when preparing to move houses may include: giving notice to a current landlord; deciding if you want to hire a moving company; getting rid of household items; having a moving sale; changing doctors/dentists; checking insurance policies; notifying the post office and filling out a change-of-address form; scheduling TV and internet service disconnection/re-connection; and emailing new address to friends and family.

Each template event may include: an event title, a date for the template event which may be specified as an offset amount from the main event, a time (or duration for the event), a description, and information regarding how the template event should be displayed. Display information may include style and color preferences.

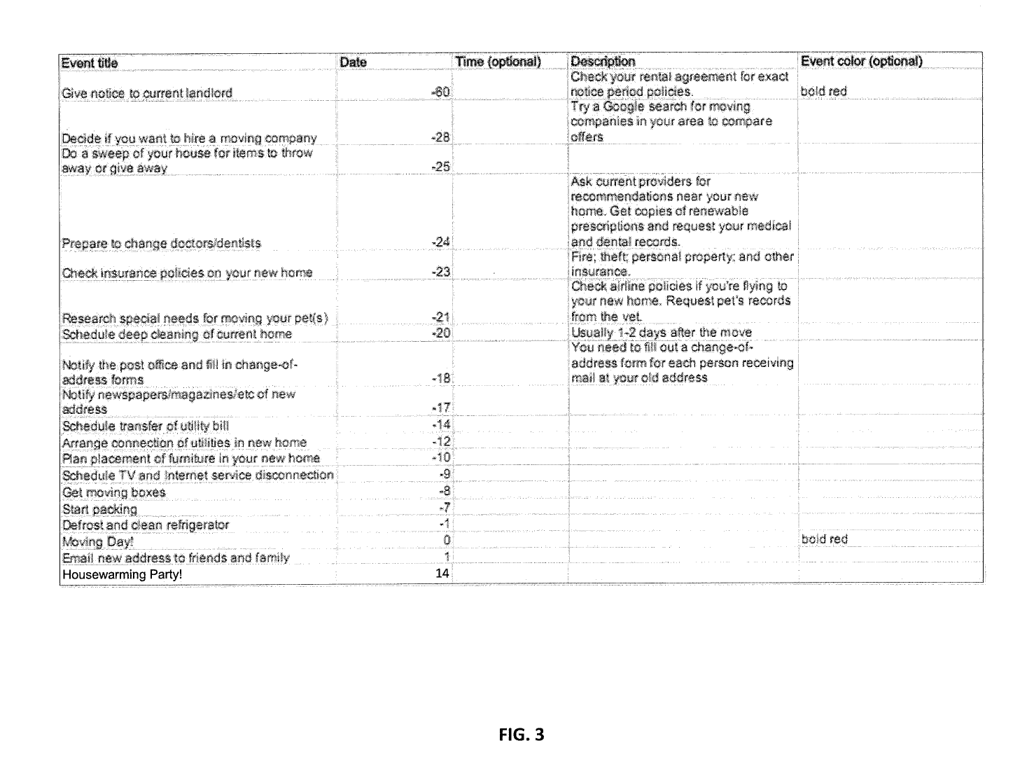

Although a template of events may be a good starting point for users to know which preparation tasks need to be completed, users may want to customize templates by deleting certain tasks and adding other tasks. An exemplary system may allow a user to modify a pre-defined event template before populating the user's calendar with template events. For example, a user may not want to hold a moving sale before the move, but may want to hold a house warming party two weeks after moving into his or her new home. FIG. 3 illustrates a modified moving house template in which “decide if you want to hold a moving sale” has been removed and “house warming party” has been added. In order to modify a template, an exemplary system may provide a user interface that allows a user to choose and preview a template. After previewing a template, the user may be able to decide whether to modify, delete, or add events to the template. Customized templates may be saved for later use. These templates may also be shared with other users. If a template is made available to other users, access control features may be enabled to restrict access, use, and/or editing of the template.

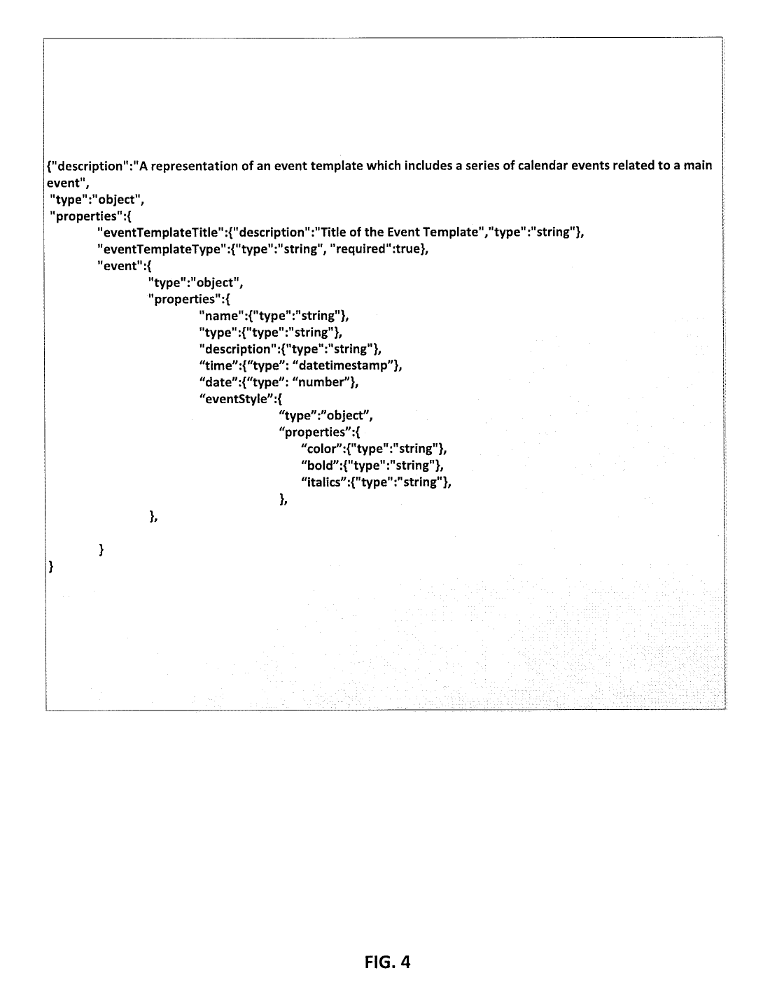

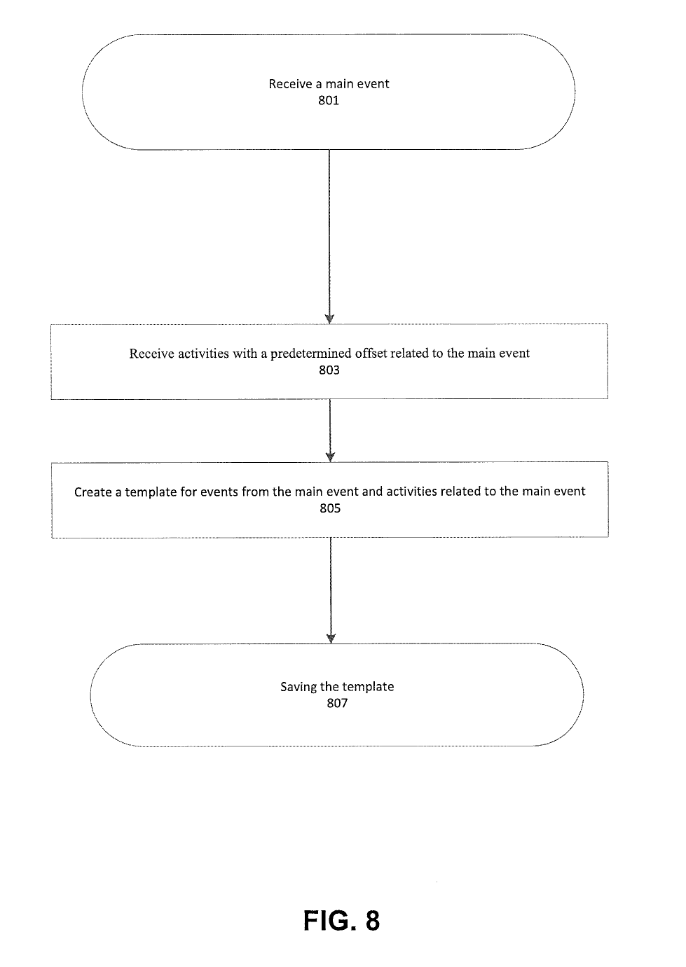

Not only may users use calendar event templates to populate their calendars, but users may create their own templates. To create templates, users and/or third-party systems may use a calendar event template schema. A schema is a framework that helps organize and interpret information. A schema is typically used to define validation rules and verify received data. Some schemas describe data objects, data object interrelationships, and methods for the data objects. An exemplary calendar event template schema may be available within a calendar system so that a user may define his or her own calendar event templates. FIG. 4 illustrates an example calendar event template schema which may be used by users to create their own calendar event template instance. An exemplary system may receive a main event for which a template should be created from a user as illustrated in FIG. 8 (801). The system may then receive a list of activities related to the main event (803). Templates may be created from the received main event and the related activities (805). Templates may be written in JSON, XML, HTML, or some other output format. Templates may also be uploaded into an exemplary system for the user to use to schedule events on his or her calendar. The templates may then be saved and available for use (807). Templates may be associated with one or more keywords to identify the subject matter of the template. Templates may also be associated with one or more categories in order to organize templates by subject matter or type. An event template creator may be able to specify whether the template he or she created is available for others to use. The template creator may designate a template to be private, public, or available to a select group of users. If the template is available to a user, the user or the system may be able to choose the template when the user creates a new event.

In some embodiments, templates may be imported from third-party sites. A third-party site such as a wedding website or a baby website may create lists of activities that may either be translated into templates or may be in a format acceptable to the exemplary system. Activities and events from third-party systems may be received by the exemplary system and saved as templates for users future use.

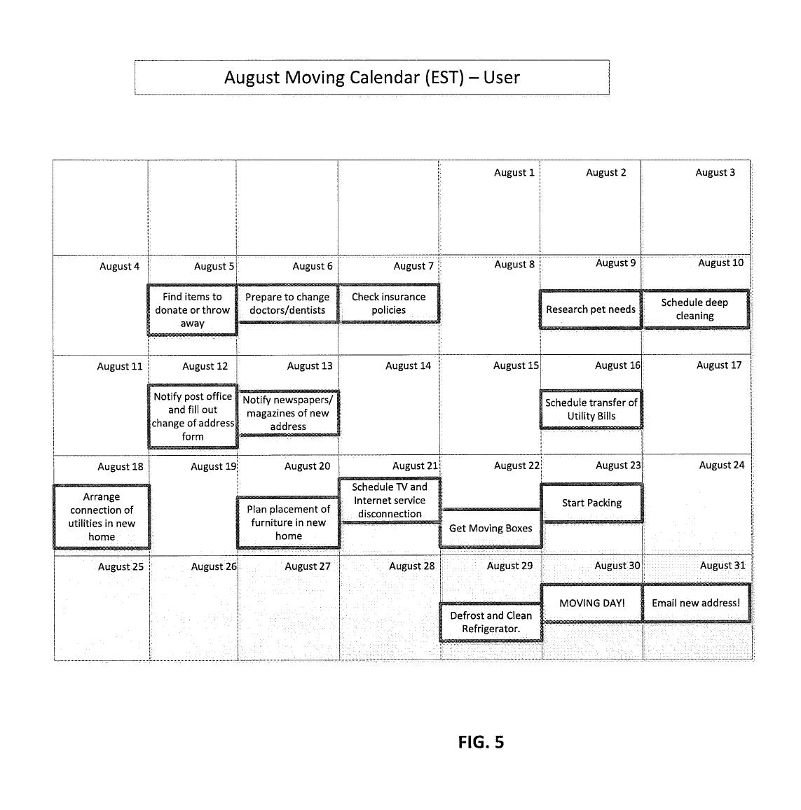

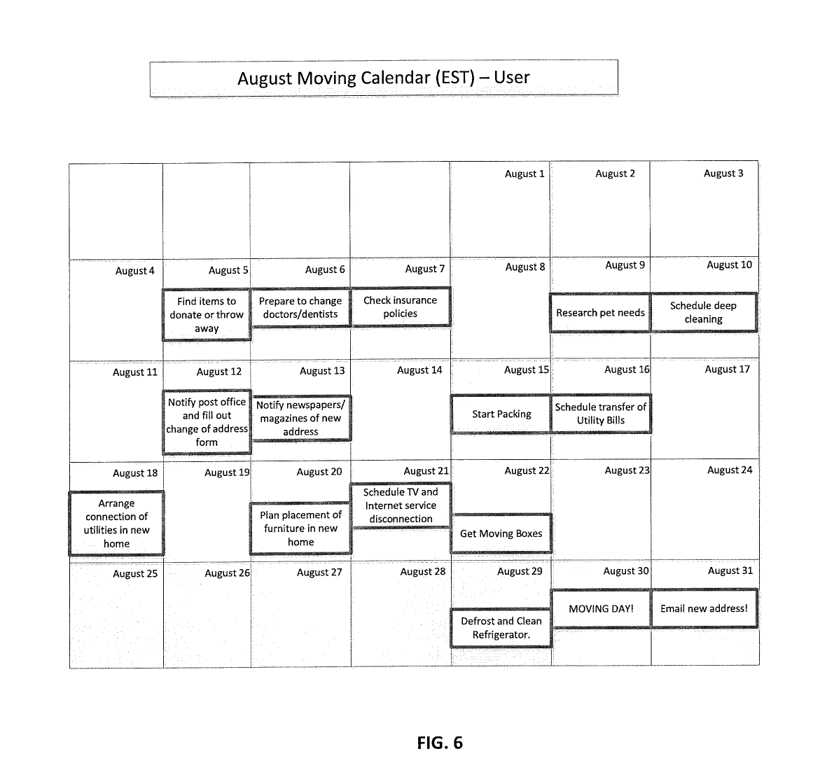

After an event template is selected, template events may populate a user's calendar as illustrated in FIG. 5. Once events are scheduled on a user's calendar, the events may be deleted or modified like any other event on the user's calendar. For example, calendar template events may be moved to a different day or time. As illustrated in FIG. 6, a user may change the date to “start packing” from seven days before the moving day to fifteen days before the move. Additional events may also be created that the user may designate as part of the main event tasks. These events may all be grouped together and treated as a series of events by an exemplary calendar system. When deleting the main event from the event group from the user's calendar, the user may also have the option of deleting all events in the event group. Additionally, when deleting or modifying one event from the event group, the user may have the option of deleting or modifying all other events or events that are similar to the event from the event group.

An exemplary system may also include reminders for template events. These reminders may default to a specific time prior to an event for all events in the template. However, each event may have customized reminders associated with the event. For example, using the events of FIG. 2, a reminder may not be needed for deciding whether to hire a moving company so a reminder for this event may be deleted or not created. For changing the user's address with the post office, a user may want to set a reminder to notify the post office and fill in a change-of-address forms every time the user is near the post office. The user may then customize reminders for this event by entering in the address of the post office so that the system can recognize when the user is near the post office and send a reminder.

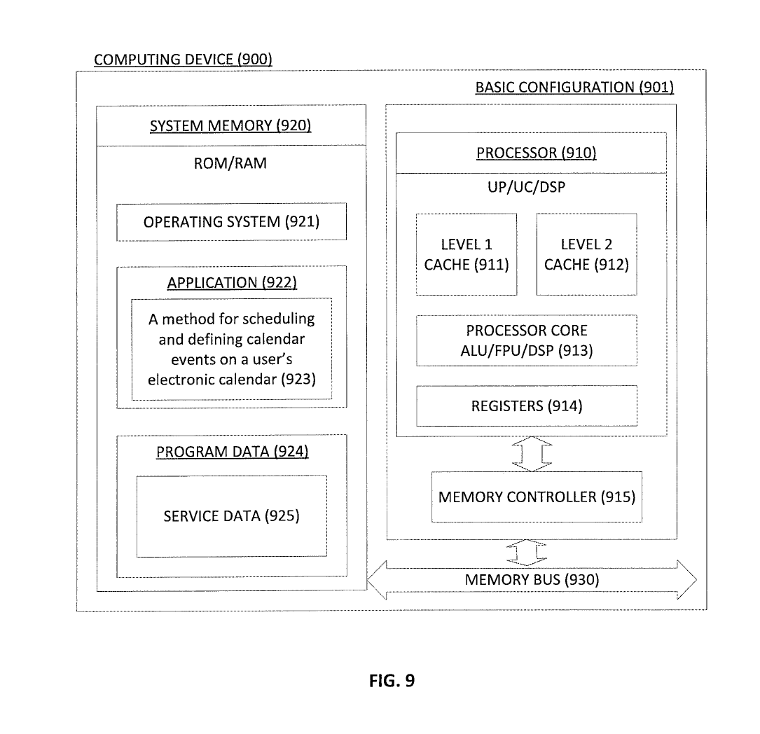

FIG. 9 is a high-level block diagram of an example computer (900) that is arranged for scheduling and defining calendar events on a user's electronic calendar. In a very basic configuration (901), the computing device (900) typically includes one or more processors (910) and system memory (920). A memory bus (930) can be used for communicating between the processor (910) and the system memory (920).

Depending on the desired configuration, the processor (910) can be of any type including but not limited to a microprocessor (μP), a microcontroller (μC), a digital signal processor (DSP), or any combination thereof. The processor (910) can include one more levels of caching, such as a level one cache (911) and a level two cache (912), a processor core (913), and registers (914). The processor core (913) can include an arithmetic logic unit (ALU), a floating point unit (FPU), a digital signal processing core (DSP Core), or any combination thereof. A memory controller (916) can also be used with the processor (910), or in some implementations the memory controller (915) can be an internal part of the processor (910).

Depending on the desired configuration, the system memory (920) can be of any type including but not limited to volatile memory (such as RAM), non-volatile memory (such as ROM, flash memory, etc.) or any combination thereof System memory (920) typically includes an operating system (921), one or more applications (922), and program data (924). The application (922) may include a method for scheduling and defining calendar events on a user's electronic calendar. Program Data (924) includes storing instructions that, when executed by the one or more processing devices, implement a method for using a template to populate a user's calendar with events related to a main event. (923). In some embodiments, the application (922) can be arranged to operate with program data (924) on an operating system (921).

The computing device (900) can have additional features or functionality, and additional interfaces to facilitate communications between the basic configuration (901) and any required devices and interfaces.

System memory (920) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media can be part of the device (900).

The computing device (900) can be implemented as a portion of a small-form factor portable (or mobile) electronic device such as a cell phone, a smartphone, a personal data assistant (PDA), a personal media player device, a tablet computer (tablet), a wireless web-watch device, a personal headset device, an application-specific device, or a hybrid device that include any of the above functions. The computing device (900) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), other integrated formats, or as a web service. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., fiber optics cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for scheduling and defining calendar events on a user's electronic calendar, the method comprising:
identifying a third-party site that creates at least one list relating to an event, the list containing activities and events corresponding to the event;
importing the list with the activities and events from the third-party site and storing the activities and events as a template for the user's electronic calendar;
creating a calendar event template instance from the template, the calendar event template instance including a plurality of template events based on the activities and events, with each template event having an event date specified as a predefined offset value before a specified date of a main event;
receiving, from the user, information identifying the main event with the specified date and a title;
parsing the title of the main event;
determining, based on the title of the main event, that the main event is associated with the event for which the third-party site creates the list, and is related to the calendar event template instance;
populating the user's electronic calendar with the plurality of template events from the calendar event template instance using the specified date of the main event as a date before which dates of the plurality of template events are offset using the template events' predefined offset values; and
creating an event group including the plurality of populated template events on the user's electronic calendar.

2. The computer-implemented method of claim 1, further comprising responsive to the user deleting the main event, providing the user with an option to delete the plurality of populated template events within the event group.

3. The computer-implemented method of claim 1, further comprising responsive to the user deleting one of the populated template events, providing the user with an option to delete the other populated template events and the main event.

4. (canceled)

5. The method of claim 1, further comprising modifying a populated template event.

6. The method of claim 1, further comprising creating a calendar event that is associated with the created event group.

7. The method of claim 1, further comprising including reminders in at least one of the populated template events.

8. A computer-implemented method for creating template events on a user's electronic calendar, the method comprising:
identifying a third-party site that creates at least one list relating to an event, the list containing activities and events corresponding to the event;
importing the list with the activities and events from the third-party site and storing the activities and events as an event template for the user's electronic calendar;
receiving, from the user, information identifying a main event;
creating, from the event template, an event template instance based on the activities and events, each template event having an event date specified as a predefined offset value before a specified date of the main event;
saving the event template instance as the event template;
parsing the main event;
determining, based on parsing the main event, that the main event is related to the saved event template instance; and
upon determining that the main event is related to the saved event template instance, populating a user's electronic calendar with the template events at the predefined offset values before the specified date of the main event.

9. The computer-implemented method of claim 8, further comprising providing an event template schema with which additional event template instances can be created.

10. The computer-implemented method of claim 8, further comprising receiving customization of the saved event template instance before populating the user's electronic calendar with template events.

11. (canceled)

12. The computer-implemented method of claim 8, further comprising receiving access control restrictions to limit availability of the saved event template instance.

13. The computer-implemented method of claim 12, further comprising displaying the saved event template instance.

14. A calendar system for scheduling and defining calendar events on a user's electronic calendar, the system comprising:
one or more processing devices; and
one or more storage devices storing instructions that, when executed by the one or more processing devices, cause the system to:
identify a third-party site that creates at least one list relating to an event, the list containing activities and events corresponding to the event;
import the list with the activities and events from the third-party site and storing the activities and events as a template for the user's electronic calendar;
create a calendar event template instance from the template, the calendar event template instance including a plurality of template events based on the activities and events, with each template event having an event date specified as a predefined offset value before a specified date of a main event;
receive, from the user, information identifying the main event with the specified date and a title;
parse the title of the main event;
determine, based on the title of the main event, that the main event is associated with the event for which the third-party site creates the list, and is related to the calendar event template instance;
populate the user's electronic calendar with the plurality of template events from the calendar event template instance using the specified date of the main event as the date before which dates of the plurality of template events are offset using the template events' predefined offset values; and
create an event group including the plurality of populated template events on the user's electronic calendar.

15. The calendar system of claim 14, wherein the instructions further cause the system to, responsive to the user deleting the main event, provide the user with an option to delete the plurality of populated template events.

16. The calendar system of claim 14, wherein the instructions further cause the system to, responsive to the user deleting one of the plurality of template events, provide the user with an option to delete the remaining populated template events and the main event.

17. The calendar system of claim 14, wherein the instructions further cause the system to modify a populated template event.

18. The calendar system of claim 14, wherein the instructions further cause the system to create a calendar event that is associated with the event group.

19. (canceled)

20. The calendar system of claim 14, wherein the instructions further cause the system to add reminders to the template events.

21. The calendar system of claim 14, wherein the determining that the main event is related to the calendar event template instance comprises determining that the main event is related to the calendar event template instance based on applying machine learning to the parsed title of the main event.

22. The method of claim 1, wherein the determining that the main event is related to the calendar event template instance comprises determining that the main event is related to the calendar event template instance based on applying machine learning to the parsed title of the main event.

23. The method of claim 1, wherein the template is written in at least one of JSON, XML, or HTML.
